(19) United States
(12) Patent Application Publication
(10) Pub. No.: US 2024/0366335 A1
(43) Pub. Date: Nov. 7, 2024

(54) ELECTRONIC FLUID CONTROL IN DENTAL DELIVERY SYSTEM

(71) Applicant: A-dec, Inc., Newberg, OR (US)

(72) Inventors: Eric Walters, Newberg, OR (US); Warn Jackson, Newberg, OR (US); Steve Van Bergen, Newberg, OR (US)

(73) Assignee: A-dec, Inc., Newberg, OR (US)

(21) Appl. No.: 18/143,029

(22) Filed: May 3, 2023

(51) Int. Cl. A61C 1/05

(52) U.S. Cl. CPC A61C 1/052

(57) ABSTRACT

A water coolant circuit for a dental unit includes a plurality of defined dental device positions to which dental devices that use water coolant can be connected and a water coolant valve connected to the plurality of dental device positions and connectible to a pressurized water coolant source. The water coolant valve is operable via pulse width modulation (PWM) and selectively controllable to supply the water coolant from the water coolant source to at least one of the plurality of dental device positions at a time. The water coolant valve used for the plurality of dental device positions can have an associated water holdback valve for each of the dental device positions. A new proportional air coolant valve is described.

### BACKGROUND

Dental delivery systems provide the physical connections for delivering air, water, electrical power and/or data to dental devices that practitioners use in carrying out dental treatments for patients. Dental devices used with delivery systems (sometimes also referred to familiarly as “handpieces”) include dental air/water syringes, air-driven rotary dental handpieces (high speed, low speed), electrically-driven rotary dental handpieces, ultrasonic scaling handpieces, air/water abrasion polishing handpieces, dental lasers, and other devices that are typically handheld by a practitioner and supplied from a delivery system. A control head of a dental delivery system has at least one dental device position, but more typically, multiple dental device positions, which are each designed to receive a dental device. Control heads with multiple dental device positions are common because typical treatment procedures involve using two or more dental devices. At least some of the dental device positions have connections to sources of pressurized fluids (typically air and treated water), which are used for cooling the treatment area, providing drive power in some types of dental devices, irrigation, drying and/or removing material, among other uses.

A dental device that uses water has a tubing (also sometimes referred to as a waterline) through which the water is conveyed from the control head to the dental device. Similarly, a dental device that uses air has a tubing through which air is conveyed from the from the control head to the dental device. Some dental devices that use air and water have both air and water tubings, which among other capabilities allows for the air and water being mixed to generate a desired spray, e.g., in an internal chamber or external to the dental device.

Fluid control in dental delivery systems presents opportunities because some current approaches lead to complicated designs that add to initial cost and can be expensive to maintain. At the same time, practitioners seek greater flexibility in controlling how their dental devices can be used, as well as access to enhanced features not previously available.

### SUMMARY

Described below are new apparatus and methods that address challenges in current approaches to fluid control in dental delivery systems.

According to a first implementation, a water coolant circuit for a dental unit comprises a plurality of defined dental device positions to which dental devices that use water coolant can be connected and a water coolant valve connected to the plurality of dental device positions and connectible to a pressurized water coolant source. The water coolant valve is operable via pulse width modulation (PWM) and selectively controllable to supply the water coolant from the water coolant source to at least one of the plurality of dental device positions at a time.

According to a method implementation, supplying dental water coolant in a dental delivery system comprises providing a single water coolant valve connected to multiple dental device positions defined on a control head, connecting the single water coolant valve to a pressurized dental water coolant source, and operating the water coolant valve via electronic pulse width modulation (PWM) to selectively control a flow of dental water coolant from the single water coolant valve to at least a selected one of the multiple dental device positions.

According to another implementation, a water coolant holdback valve for use in a dental unit, comprises a valve body having a valve inlet and a valve outlet for water coolant, a flexible diaphragm positioned in the valve body between the valve inlet and the valve outlet. The flexible diagram is selectively controllable to allow inflow of water coolant from the valve inlet and outflow of water coolant through the valve outlet and to shut off inflow of water coolant. The water coolant holdback valve is connectible within the dental unit downstream of a water coolant source and upstream of a dental device position at which a dental device can be connected.

According to another implementation, a pneumatic proportional valve for supplying air coolant in a dental unit, comprises a valve inlet connected to a pressurized air source, a valve outlet selectively connectible to one of a plurality of dental device assigned positions to which a respective plurality of dental devices can be connected, and an electrical control circuit via which the pneumatic proportional valve receives signals to selectively control supply of air coolant to at least a selected one of the dental device assigned positions.

The foregoing and other objects, features, and advantages will become more apparent from the following detailed description, which proceeds with reference to the accompanying figures.

### BRIEF DESCRIPTION OF THE DRAWINGS

FIG. 1 is a block diagram of a dental delivery system having a control head, air and dental water supplies, user controls, dental devices used during treatment through which air and/or dental water are supplied and a control circuit.

FIG. 2 is a circuit diagram for a new water coolant solenoid valve using cyclical operation (e.g., pulse width modulation or PWM) to supply dental water coolant to multiple dental devices, such as a first dental device as shown schematically in FIG. 2.

FIG. 3A is a circuit diagram for the new water coolant solenoid valve of FIG. 2, except showing a second dental device that is also connected to the single water coolant solenoid valve, according to a second example.

FIGS. 3B and 3C are schematic sectional views of the new water coolant solenoid valve in closed and open states according to one implementation.

FIG. 4 is a circuit diagram for one conventional water coolant needle valve connected to supply dental water coolant to one dental device.

FIG. 5 is a circuit diagram for three conventional water coolant needle valves connected to respective dental devices.

FIG. 6 is a circuit diagram for the new water coolant valve of FIG. 2 in combination with a dental device selection solenoid valve and an air coolant proportional valve, shown for a single dental device.

FIG. 7 is a circuit diagram similar to FIG. 6, except showing the single water coolant valve and single air coolant proportional valve in use with two dental devices.

FIGS. 8, 9 and 10A are schematic drawings showing a valve diaphragm in different states.

FIG. 10B is a schematic drawing showing a valve diaphragm according to an alternative implementation.

FIG. 11 is a graph showing operation of the water coolant valve and resulting dental device water coolant flow rate and dental device water coolant pressure as the valve is operated according to a selected frequency and duty cycle.

FIG. 12 is a graph showing the effects of system capacitance at two levels in smoothing out PWM-generated flow through a dental device (handpiece).

FIG. 13 is a graph showing the effect of PWM duty cycle at two rates in controlling mean flow through the dental device (handpiece).

FIGS. 14A-14D are graphs of pressure variations measured at the water coolant valve outlet and the dental device (handpiece) inlet at four different PWM frequencies.

### DETAILED DESCRIPTION

Described below are embodiments of electronic fluid control used in connection with dental delivery systems and methods.

### Overview

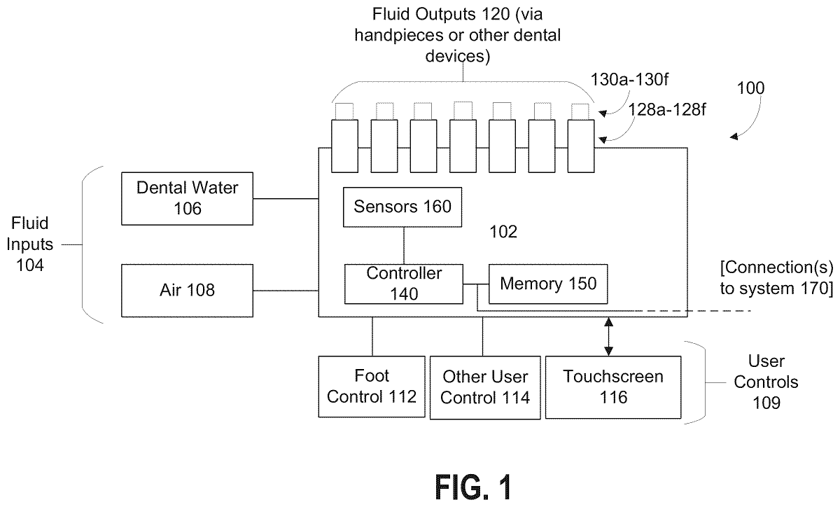

FIG. 1 is a schematic block diagram of a dental delivery system 100 having electronic fluid control, according to one implementation. The dental delivery system typically has a control head 102 that is connected to receive one or more fluid inputs 104. The fluids in a dental delivery system typically include dental water and pressurized air, as are described below in greater detail. Thus, there is a dental water source 106 for supplying water at desired pressure(s), temperature(s) and state(s) of treatment. The dental water source 106 may be a direct connection to the building water supply or an independent bottled water system (sometimes referred to as a self-contained water system). There is a dental air source 108 for supplying air at desired pressure(s).

The dental delivery system has user controls 109, typically used by the dentist or other practitioner, to initiate and control delivery of one or more of the fluids during treatment of patients. The user controls 109 can include one or more of a foot control 112, a user control 114 (such as a hand control, a user-worn control, or other type of user-actuated control) and a touchscreen 116, as three examples. In addition to serving as a user control, the touchscreen 116 (or another display device) can serve as an output device to display information about the operation of the system.

As also shown in FIG. 1, there are various fluid outputs 120 from the control head 102 that use the available fluid sources. Typically, the fluids are used (or consumed) through one or more dental devices 130a-130f. The dental devices 130a-130f are connected to the control head 102 at respective dental device positions 128a-128f via respective tubings through which the fluids are supplied. Although the illustrated implementations can be interpreted to refer to physical dental device positions, the same concepts apply to alternative implementations in which the dental device “positions” are logical assignments that may or may not have a defined physical location(s) relative to the control head 102.

Representative types of dental devices are dental syringes, air-driven dental devices (high speed, low speed), electrically driven dental devices, surgical dental devices, hygiene dental devices, ultrasonic dental devices, and others.

In some dental devices, dental water is supplied as a coolant to lower the temperature of the treatment site in the oral cavity. In some dental devices, air may be mixed with dental water to achieve a desired spray. Air is also used to dry surfaces and clear away debris. Further, air may also be provided as a source of energy (“drive air”) for pneumatically operated dental devices. It would also be possible to use air as a coolant.

The control head 102 houses the connections between the fluid inputs 104, the user controls 109 and the various fluid outputs 120 via the dental devices, together with electronic and fluid control elements (e.g., valves) for controlling how fluids are supplied. The control head may include other elements that are used in providing patient care and are conveniently housed in or on the control head 102, but are not shown or described because they are not primarily related to the use of fluids as described herein.

The control head 102 includes an electronic control circuit, including one or more controllers 140, a memory 150, one or more optional sensors 160 and connections to the system 170. Portions of the control circuit can be housed in the control head 102, as well as distributed at other locations of an overall dental treatment system.

Representative control heads, also referred to as dental units, are described in assignee's U.S. Pat. No. 11,185,389 B2, which is incorporated herein by reference.

### New Water Coolant Circuits

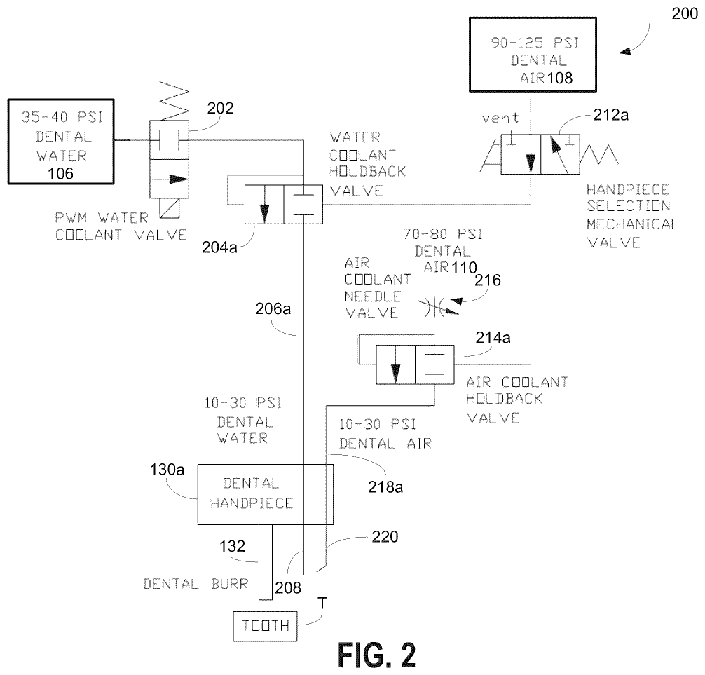

According to some implementations, a new water coolant circuit 200 comprises a single, central water coolant valve that serves multiple dental devices (instead of needing one valve for each dental device), as well as other new components as described below. First, FIG. 2 is a circuit diagram showing a single water coolant valve 202 that is connected to supply pressurized dental water to a first dental device 130a. The water coolant valve 202 is connected to a dental water source 106. In this example, the dental water source 106 supplies dental water at a pressure of 35-40 psi. In other implementations, lower pressures are used, such as, e.g., 25-40 psi.

The water coolant valve 202 operates by pulse width modulation (PWM) to supply water to the rest of the water coolant circuit 200. In the example of FIG. 2, the water coolant valve 202 is a two-position, servo-controlled valve that receives inputs of frequency and pulse width as operating parameters, as described below in greater detail.

The water coolant valve 202 is connected to a first water coolant holdback valve 204a associated with the first dental device 130a. The first water coolant holdback valve 204a is a two-position, normally closed valve that prevents (or “holds back”) flow to the rest of the circuit until it is triggered to move to an open position. When the first water coolant holdback valve 204a is in the open position, and following the left side of the circuit, water coolant is supplied via the first line 206a to the first dental device 130a, and is emitted as coolant at a distal end 208 to cool a treatment site. The same concepts apply to dental devices having internal mixing chambers where mixing occurs internally before the mixture is emitted. For example, the water can be used to cool a dental burr 132 operated by the first dental device 130a and/or an associated tooth or teeth T at the treatment site.

In the example of FIG. 2, the first water coolant holdback valve 204a is connected to a first dental device selection valve 212a to receive a signal indicating that the associated first dental device 130a is prepared for use, which causes the first water coolant holdback valve 204a to move to an open position. In the example of FIG. 2, the first dental device selection valve 212a sends an air signal to the first water coolant holdback valve 204a to cause it to open and permit water coolant to flow in the first line 206a.

In some implementations, the dental device selection valves (also sometimes referred to as “holder valves”) are mechanical two-position, three-way valves that detect when a respective dental device is removed from its holder or an associated whip arm holding the dental device is moved away from a storage position. As shown in FIG. 2, the first is connected at its inlet to a dental air source 108 that provides pressurized air. In this example, the dental air source 108 provides pressurized air at 90-125 psi.

When the dental device is located in its respective holder, a mechanical lever is activated, and the inlet is connected to an outlet pilot signal. When the dental device is removed from the holder, the valve lever is not activated, so the outlet pilot signal is vented and the inlet is closed off.

While the dental device is removed from the holder, the user can actuate a controller (e.g., a foot control, a hand control or other control) to initiate a water coolant flow through the dental device.

When the first dental device 130a is located in its holder, the presence of the pilot air signal from the first dental device selection valve 212a closes a first air coolant holdback valve 214a associated with the first dental device 130a. The first air coolant holdback valve 214a prevents (or “holds back”) air from an air coolant needle valve 216. In the illustrated implementation, the first air coolant holdback valve 214a is a two-position, two-way pilot operated air valve. When the first dental device 130a is removed from its holder, the pilot air signal is vented, and the first air coolant holdback valve 214a opens to supply dental air coolant, once the foot control is activated.

Subsequently, the holdback valve pilot signal is repressurized. Prior to re-pressurization, any water volume in the first water coolant holdback valve 204a is pushed out the port(s) on the first dental device 130a. Generally, the user would first take their foot off the foot control disk/lever, which would switch off water coolant through the water coolant valve 202. This water flow should “snap off” quickly and not subsequently drip. The holdback valve optimization is related to hanging up the first dental device 130a after the water coolant valve 202 has already been shut off, but then any volume of water stuck in the holdback valve volume when holdback pilot pressure returns does not push that volume out the handpiece coolant ports.

The air coolant needle valve 216 is connected to a dental air coolant source, such as a dental air source 110. In this example, the dental air source 110 provides pressurized air at 70-80 psi.

The air coolant needle valve 216 is a mechanical needle valve with an inlet, an outlet and a needle, which creates a variable sized orifice between the inlet and the outlet. The air coolant needle valve 216 is user-adjustable over a range. For example, with 70-80 psi dental air at the inlet, the air coolant needle valve 216 can be adjusted to produce air coolant within a range of 5-60 psi pressure at the outlet.

When the first air coolant holdback valve 214a is opened, dental air from the air coolant needle valve 216 flows through a line 218a to the first dental device 130a and is emitted at a distal end 220, shown schematically in FIG. 2. The air coolant is typically combined with the water coolant, either within the dental device or external to the dental device, to create a spray as desired. In other implementations, it may be possible to use air coolant alone.

As described, the water coolant valve 202 is a single valve that is used to supply dental coolant to multiple dental devices. The dental devices are typically used one at a time, but two or more dental devices may be controlled to operate simultaneously, such as during a flushing operation, as is described below in more detail.

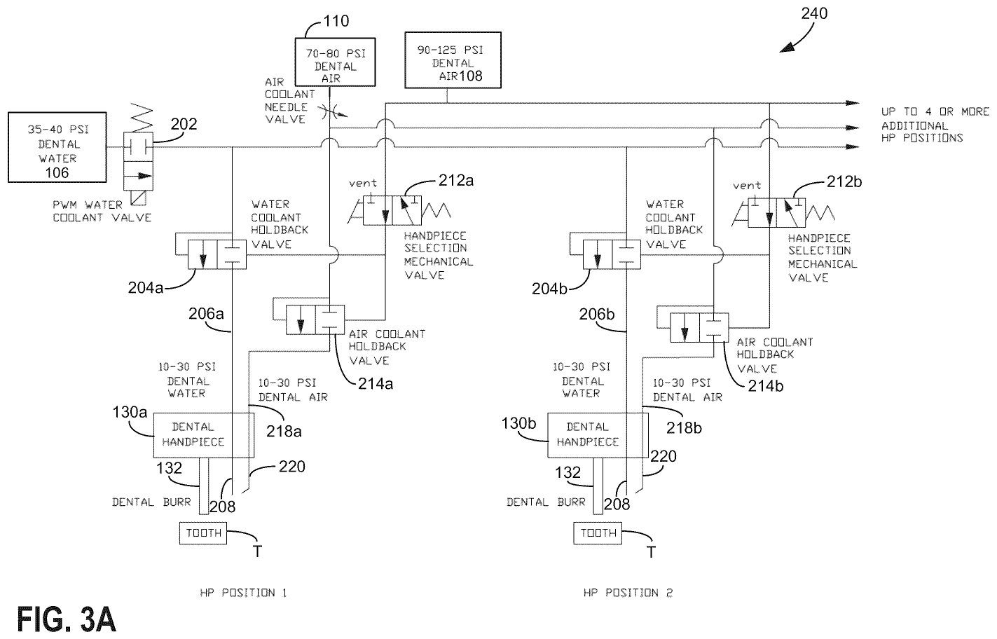

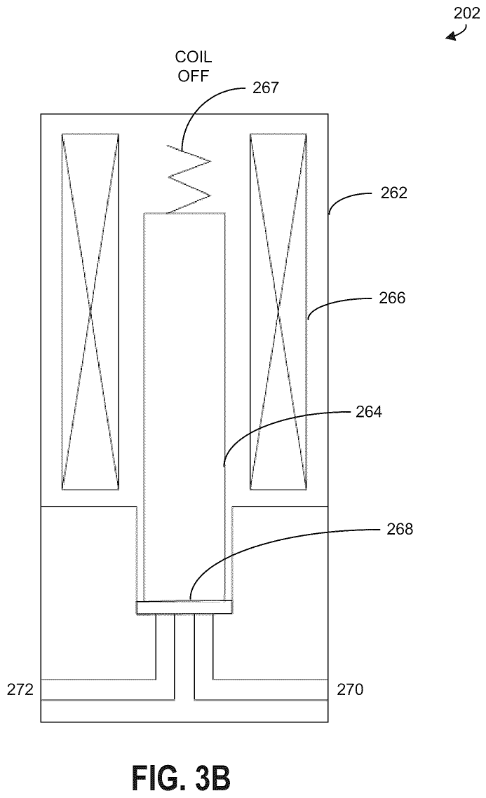

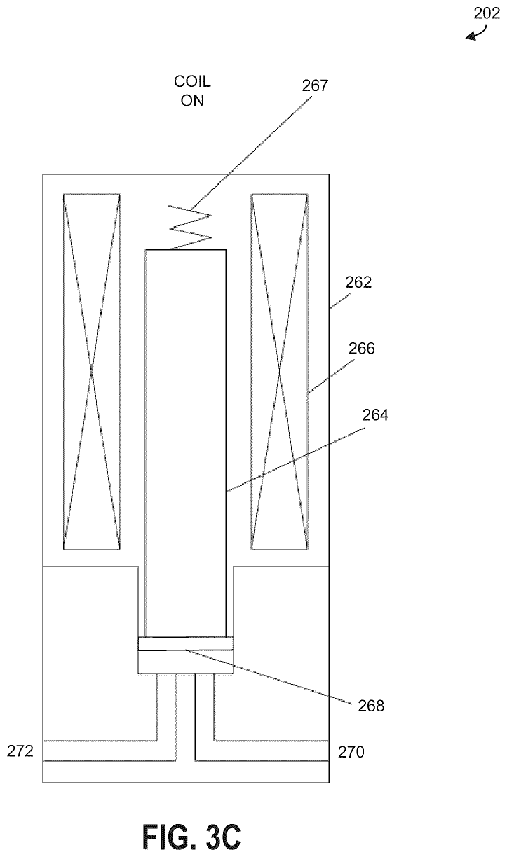

In FIG. 3A, a circuit 240 in which the water coolant valve 202 is connected to multiple dental devices, e.g., the first dental device 130a and a second dental device 130b, is shown. In the circuit 240, the connections between the water coolant valve 202 and the first dental device 130a are the same as in FIG. 2. Similarly, in the branch of the circuit for the second dental device 130b shown on the right, there is a second water coolant hold back valve 204b, a second line 206b, a second dental device selection valve 212b, a second air coolant holdback valve 214b and a second line 218b. Thus, there is a single water coolant valve, and there is a water coolant holdback valve, a dental device selection valve and an air coolant holdback valve for each connected dental device.

### Single Water Coolant Valve

FIGS. 3B and 3C are schematic sectional views of a representative example of the water coolant valve 202, which can be used as a single valve for supplying water coolant to multiple dental devices. In FIG. 3B, the water coolant valve 202 is shown in a closed state. In FIG. 3C, the water coolant valve is shown in an open state.

The water coolant valve 202 has a body 262, an armature 264, a coil 266 and a coil spring 267. The coil 266 is energized to cause the armature 264 to reciprocate, which in turn moves a diaphragm seal 268 to allow fluid to flow in from the inlet 270 and out through the outlet 272. In the illustrated implementation, the water coolant valve 202 is an isolation valve designed such that only a minimal number of components contact the fluid because of the sealing action of the diaphragm seal 268. The simplified flow path as shown helps prevent biofilm growth by minimizing nooks, crannies and dead-end passages where fluid, particularly water, can be retained. In addition, valve components can be made of inert materials.

There are commercially available PWM valves that may allow for basic operation and/or a proof of concept of the water coolant valve implementations described herein. But the commercially available PWM valves as presently understood fail to meet at least some design requirements, so a modified valve is needed.

As described, the water coolant valve 202 in some implementations is a specialized high-speed, two-position, two-way, normally-closed, on/off solenoid valve used for multiple purposes in the dental water circuit. It has a simple, robust and low-cost design. It can deliver very low flow rates but also handle high flow rates, such as during a full flush function. In some implementations, a valve with a nominal orifice diameter of roughly 0.030-0.039 inch may meet the dual needs. In some implementations, a target orifice nominal diameter is 0.035 inch. This would equate to a roughly 0.008 inch stroke, so that the poppet open orifice has this same orifice area.

The water coolant valve 202 also provides an isolation-type valve design, which is desired to address general dental water quality concerns, including biofilm mitigation. In addition, it has a long life and provides consistent operation. It has a relatively small size and low moving weight, which allows for fast, robust and quiet operation. The water coolant valve 202 has a poppet stroke which backs out fully during each cycle, as well as during flush, which addresses droplet flow problems in current needle valves.

Coolant pulses occur at a rate that is imperceptible to the user, as is described below in more detail.

It is possible to use an electric or other similar motor-driven or actuator-driven needle valve or flow control valve, but these valves tend to be more expensive, more complicated and less robust. These valves would also likely require an additional on/off valve to completely meet the application requirements.

It is also possible to use a proportional solenoid valve (or an equivalent device), but the small orifices required for low flow water coolant have clogging risks and higher flow flush needs cannot easily be met without more parts and complexity.

The water coolant valve 202 allows for use of programmable water coolant flow capabilities through the user interface such that water coolant and/or flush flows can be specified for different users, dental devices and/or procedures. Preferences can also be set. Enhanced features such as water coolant flow management to make vision easier and optimize tooth/tool cooling in higher-end systems can be programmed. In some cases, signals from electronic instrumentation such as tool load sense, microphones, temperature sensors, etc., can be used as additional inputs for optimal cooling and vision. It is also possible to controllably provide a minimum flow that is effective for cooling yet still allows excellent vision (avoiding situations where so much coolant is provided that the practitioner cannot see).

With the water coolant valve 202, manual, semi-automated (timed) or fully automated dental device flushing are possible. Existing mechanical foot controls can continue to be used, in some cases with an added foot control water toggle sensor. Electronic foot controls (wired or wireless) can be easily integrated.

The water coolant valve 202 is considered a failsafe design due to its spring-activated, normally closed configuration, so the system is protected from excessive water leaks if power or system pressure is lost.

Closed loop control can be integrated if greater flow rate consistency over time is desired.

In operation, once a dental device is removed from its holder, the foot control is used to turn the water coolant valve 202 on and off. In some implementations, the water coolant valve 202 begins allowing water to flow when a pressure transducer senses drive air pressure from foot control actuation increasing above 8-12 psi. The water coolant valve 202 valve will stop allowing water flow as the foot control approaches complete deactivation (i.e., the user removes their foot force on the foot control, resulting in de-activation) and the drive air pressure drops below about 5 psi.

In other implementations, in addition to foot control activation, one or more other parameters are used in controlling when water coolant flow is initiated.

It is also possible to program the user interface and accompanying software to correlate water flow with foot control movement (e.g., percentage of foot control travel) and/or drive air pressure. Water flow in the water coolant valve 202 valve can also be tied to external sensors (pressure, temperature, flow, sound, etc.), which optionally can be in concert with the foot control actuation percentage, to optimize water spray (i.e., mixed water coolant and air coolant) for optimal tooth cooling and optimal vision of the operator. Drive air, air coolant and water coolant can all be orchestrated with foot control operation and/or external sensors, including for clear vision of the work area for the operator, as well as optimal tooth and dental device tool/burr cooling. Adjustments and pre-programming via the user interface can also optimize operator vision and tooth/tool cooling with foot control operation and/or external sensors.

### Water Coolant Holdback Valve

The new water coolant holdback valve is used to route water coolant to the desired dental device. For example, the first water coolant holdback valve 204a is used to route water coolant to the first dental device 130a. Such a holdback valve is not used currently. Because the water coolant valve 202 provides a failsafe design that protects against a loss in power or pressure, simpler and less expensive water coolant holdback valves can now be used for the circuit selection function. The water coolant holdback valve also avoids dental device water retraction and the generation of water droplets on the dental device after the dental device is replaced in the holder. The water coolant holdback valve parts and geometry have been optimized to work robustly to control water coolant flow while avoiding the retraction and droplet generation problems.

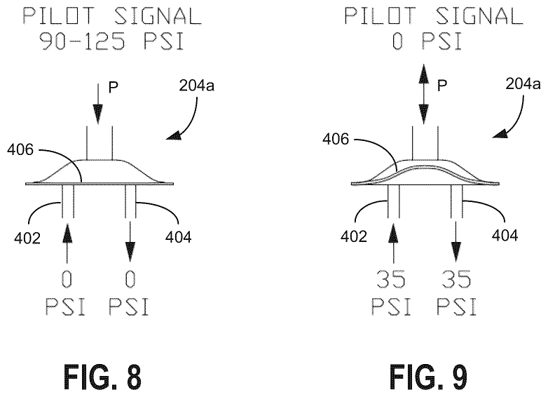

FIGS. 8, 9, 10A and 10B are schematic section views of the first water coolant holdback valve 204a illustrating different states. Two ports 402, 404 are shown. The two ports 402, 404 have optimized shapes and locations so that when the pilot signal P is applied, a diaphragm 406 does not deform into the input opening and/or the output opening, which would cause a droplet to form on the dental device when it is returned to its holder. Also, a female cavity is sized and shaped to minimize diaphragm stretch while still providing a minimally-restrictive orifice when open and coolant is flowing.

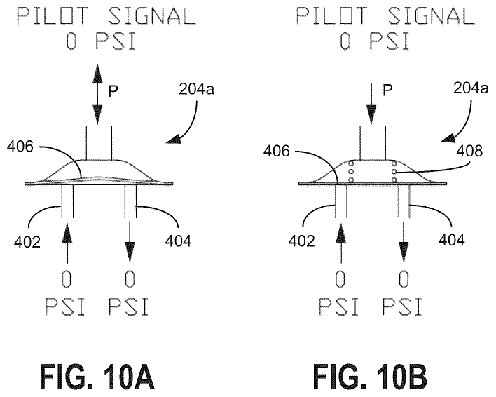

FIG. 8 shows that the pilot signal P is on, because no dental device has been selected, and the water coolant valve is off (i.e., the foot control is not depressed). FIG. 9 shows that the water coolant valve is on (i.e., the foot control is activated), and the dental device has been removed from its holder. FIG. 10A shows that the dental device is still removed from its holder, but the water coolant valve is off (i.e., the foot control is not depressed). FIG. 10A also shows some expected stretch in the diaphragm 406 over time. FIG. 10B shows an alternate construction with an added spring or similar device 408 to keep the diaphragm 406 down when no pilot signal pressure or water coolant valve pressure is present. The spring or similar device 408 reduces the occurrence of water droplet forming from the volume of water under the stretched diaphragm when the dental device is eventually returned to its holder and the pilot signal is re-pressurized.

### Pulse Width Modulated Valve Operating Considerations

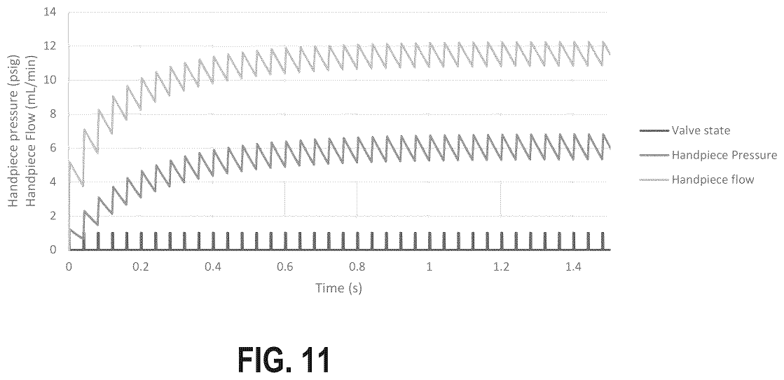

FIG. 11 is a graph showing operation of the water coolant valve 202 and the resulting dental device water coolant flow rate (upper line) and dental device water coolant pressure (middle line), as the valve rapidly changes states between on and off positions (lower line extending along horizontal axis) according to a selected frequency and duty cycle. Also, FIG. 11 shows the resulting pressure and flow variable response from the cycling of the water coolant valve 202, plus a transient ramp-up response. In the example of FIG. 11, after steady state operation is achieved, the water coolant valve 202 is providing a flow rate of 10-12 ml/min at the dental device and at a pressure of 4-6 psig at the dental device.

As described above, the water coolant valve 202 is selectively controllable to supply water coolant to at least one connected dental device at one of the dental device positions, such that the water coolant is perceived to flow continuously because the pulsations in the flow rate are not visually discernible to the user (also sometimes referred herein to as “quasi-continuous” flow).

In some implementations, an optional compliance member can be provided downstream of the water coolant valve. The compliance member can help attenuate pulsations in the water coolant flow from the water coolant valve. For example, in some implementations sufficient compliance can be achieved through a compliance member that comprises flexible tubing through which the water coolant flows. The compliance member may be a portion of the standard tubing, or it may be an added section of tubing.

In other implementations, compliance is provided by a compliance member in the form of a flexible diaphragm of a valve member. Compliance members of different types (e.g., flexible tubing, flexible diaphragms and/or other types of compliance members) may be used together.

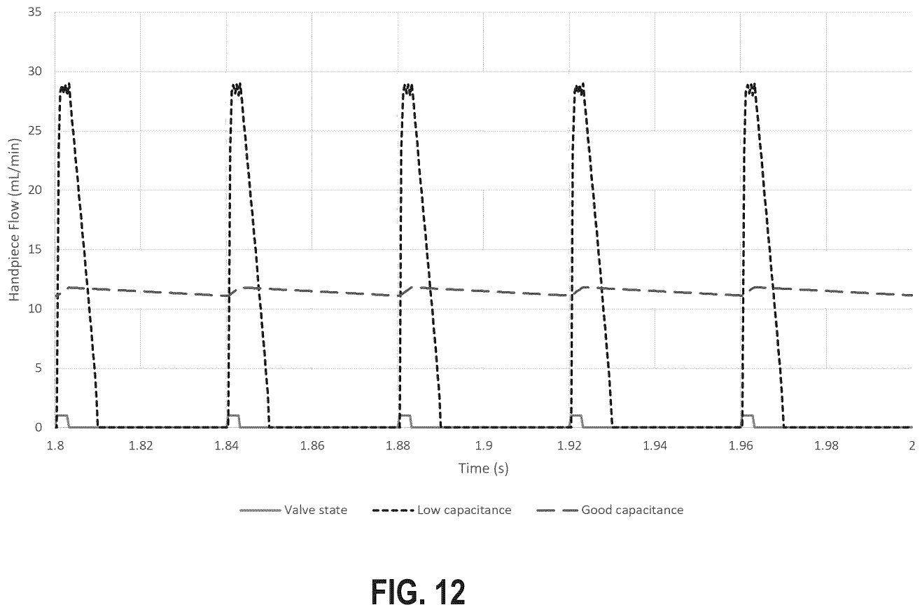

Using compliance is one approach to establishing a fluidic capacitance effect tending to result in quasi-continuous flow at the dental device. As a further illustration, FIG. 12 is a graph showing the effects of system capacitance at two levels in smoothing out PWM-generated flow from the water coolant valve 202 as it is emitted through a dental device. When capacitance is at a very low level (short dash line), the pulses in flow rate at the handpiece are pronounced and thus easily detected by a user. Conversely, when capacitance is at a sufficient level (“good capacitance”)(long dash line), the pulses in the flow rate at the handpiece are very minor. With sufficiently high or good capacitance, the flow at the handpiece appears to be smooth and continuous, and the pulses in the flow rate are not generally noticeable to the user in normal use.

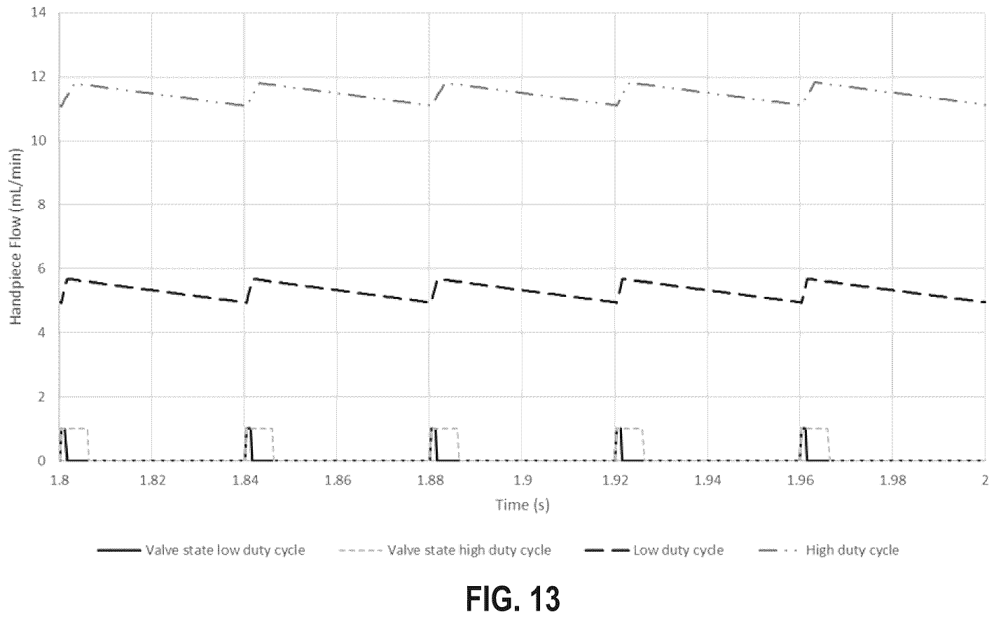

FIG. 13 is a graph showing the effect of PWM duty cycle for the water coolant valve 202 at two rates in controlling mean flow through the dental device (handpiece), with capacitance and PWM frequency being held constant for the two different rates. FIG. 13 also shows the valve state (i.e., open or closed) at the low duty cycle rate and the high duty cycle rate. As shown in FIG. 13, the effect of variation in duty cycle for the water coolant valve 202 is not well correlated to flow fluctuation at the dental device (handpiece).

In some implementations, a PWM frequency range of 15-25 Hz or 10-30 Hz provides quasi-continuous flow as desired. In some implementations, a PWM frequency of at least 15 Hz resulted in quasi-continuous flow as desired. Frequencies higher than 15 Hz yield even more continuous flow, but frequencies above 25 Hz (and the resulting very short actuation times) are difficult to achieve in some current valves. In addition, high frequency operation means the valves must sustain more cycles, which reduces reliability and increases the initial costs and the costs of replacement/maintenance over the useful life.

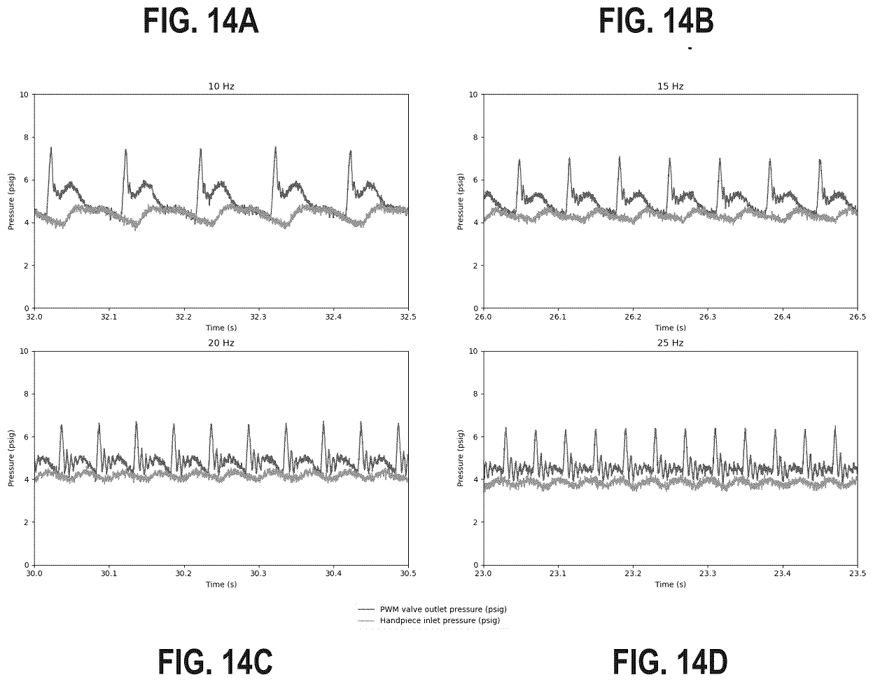

For example, FIGS. 14A-14D are graphs showing the pressures measured at the outlet of the water coolant valve and at the inlet to the dental device (handpiece) at the PWM frequencies of 10 Hz, 15 Hz, 20 Hz and 25 Hz, respectively. At the lower frequencies of 10 Hz and 15 Hz as shown in FIGS. 14A and 14B, respectively, the fluctuation in pressure at the dental device is more pronounced. At higher frequencies, such at 20 Hz and 25 Hz as shown in FIGS. 14C and 14D, respectively, the fluctuation in pressure at the dental device is lessened to the point where the resulting fluctuation in flow is not noticeable to the user (also referred to herein as “quasi-continuous” flow because it appears to the user as a continuous flow).

In some implementations, the water coolant valve 202 is operated at a selected rate sufficient to provide the desired water flow amount, as well as to provide a quasi-continuous flow Stated differently, quasi-continuous flow includes flow components that differ substantially from the mean flow, but the deviations are not perceptible to the user.

Some types of dental devices exhibit more susceptibility to showing pulses in operation, which is due at least in part to different back pressure operating regimes. A dental device in which water and air coolant are pre-mixed in an internal chamber before being expelled as a mist tolerates less flow rate fluctuation than a dental device where the air and water combine to form a mist outside the dental device.

A simple, inexpensive and robust electrical circuit allowing for quick on/off times is desired for the water coolant valve 202. In addition, special circuits to cause opening voltage to spike, but then drop voltage once shifted for power savings and heat gain reduction, can be used. The operating voltage can be 4.3 volts, 24 volts or some other robust VDC. The dental water supply pressure (conventionally, 35-40 psi) can be lowered to 25-40 psi to allow for PWM operation to be more “on time” and achieve desired flow rates precisely.

The water coolant valve 202 can have a base mounted design that accommodates ⅛″ OD and 1/16″ ID tubing on both the inlet and outlet. A manifold-mount design could optionally be used.

Various water coolant solutions can be accommodated, including 3% hydrogen peroxide solution. Similarly, various water shock solutions can be accommodated, including the A-dec ICX Renew shock solution.

In some implementations, the audible sound level of the valve should be 50 dB maximum at 1 meter from the valve in all directions. Desired flow variability with 20 Hz PWM on/off times may include the following: 3 msec on/47 msec off, 4 msec on/46 msec off, 5 msec on/45 msec off, etc. Fully shifting the poppet for flow consistency over life/time is important during the quickest fast on/off times needed for low flow water coolant (for example, about 3 msec on/47 msec off for 5 ml/min water coolant flow).

The 0.035 inch diameter orifice at 35 PSI is expected to supply more than 500 ml/minute of total flush flow. So, in a 6-dental device system with manual flush, there is ample flow to flush all six dental device tubings at the same time, if desired. If the water coolant valve stroke length is decreased from 0.008 inch to a shorter stroke length (e.g., 0.005 to 0.007) to ensure the poppet is always shifting fully during quick PWM signals, then flush flow should still be sufficient for flushing multiple dental device tubings simultaneously (even if fewer than all are flushed simultaneously).

In some implementations, the water coolant valve 202 should be capable of flows as low as 5 ml/min. Valve to valve consistency is not important, but each individual valve should be able to be adjusted to 5, 10, 15, 20, 25, 30, 40, and 50 ml/min by adjusting PWM on times at the constant 20 Hz frequency (i.e., a rate at which pulses are not perceptible to the user's eye). Flows should be consistent to +/−30% for 5 ml/min and +/−20% between 10-30 ml/min, and +/−10% for 40 or 50 ml/min for about 25,000,000 cycles. Readjustment of the low flow is possible, such as via a setting change in the user interface.

Life expectancy may be 500,000,000 cycles, 125,000,000 cycles before cleaning/rebuilding and/or 250,000,000 cycles before a re-build kit can easily and economically recondition the valve assembly.

### Conventional Water and Dental Air Circuits

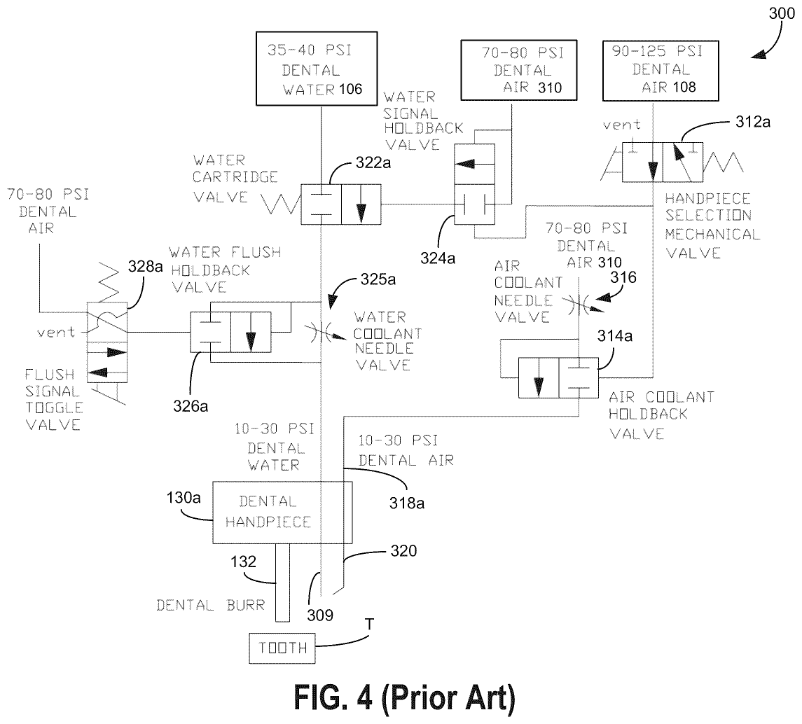

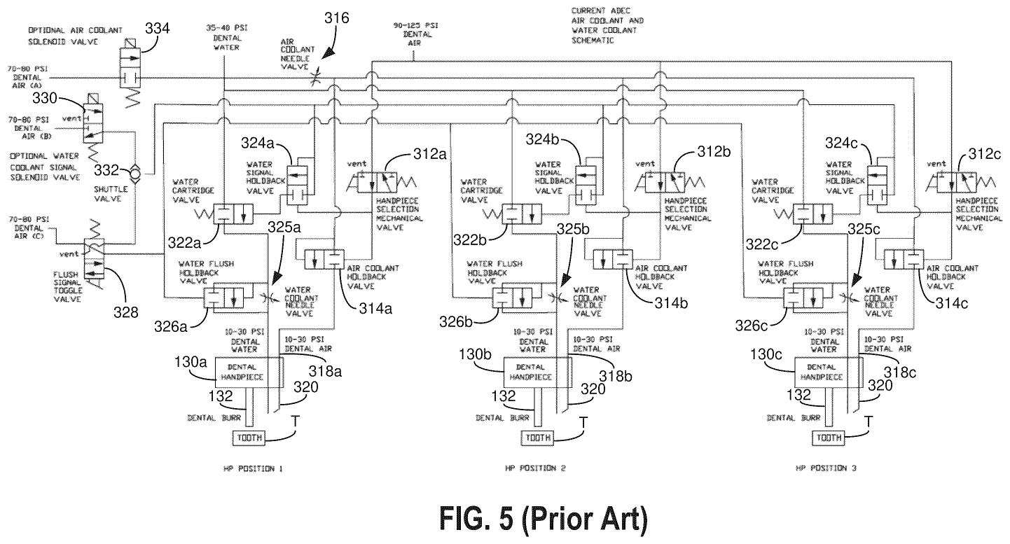

For comparison, FIG. 4 is a schematic circuit diagram showing the dental water and dental air connections in a conventional circuit 300 for a single dental device, e.g., the first dental device 130a. Similarly, FIG. 5 is a schematic circuit diagram showing the dental water and dental air connections in a conventional circuit having multiple dental devices, i.e., the first dental device 130a, the second dental device 130b and a third dental device 130c.

As indicated, a dental water source 106 supplies dental water at 35-40 psi to a first water cartridge valve 322a, which is associated with the first dental device 130a. The first water cartridge valve 322a is a two-position, two-way, normally closed, pilot operated water valve. The pilot signal is the air signal from a first water signal holdback valve 324a, described below. If power or system air pressure is lost, leaking and/or flooding are reduced because a spring in the first water cartridge valve 322a closes the valve.

When the first water cartridge valve 322a is open, water is supplied to a first water coolant needle valve 325a and the first dental device 130a, where it is emitted through a distal end 309. The first water coolant needle valve 325a is a mechanical needle valve with an inlet, an outlet and a needle, which creates a variable sized orifice between the inlet and the outlet. In the illustrated implementation, the first water coolant needle valve 325a is user adjustable and has an adjustment range capable of producing 5-30 PSI water coolant pressure at the outlet based on 35-40 psi dental water pressure at the inlet.

The first water signal holdback valve 324a, which is connected to the first water cartridge valve 322a, is a two-position, two-way pilot operated air signal valve. As best shown in FIG. 5, the first water signal holdback valve 324a is connected to the water coolant signal solenoid valve 330 (for water coolant) or the flush signal toggle valve 328 (for flushing), which are in turn connected to a dental air source that supplies dental air at 70-80 psi.

The first water signal holdback valve 324a is also connected to the first dental device selection valve 312a. The pilot signal from the first dental device selection valve 312a closes the first water signal holdback valve 324a when the pilot signal is present/pressurized (i.e., the first dental device 130a is in its holder). The first dental device selection valve 312a is connected to a dental air source 308 that supplies dental air at 90-125 psi.

When the first dental device 130a is removed from its holder, the pilot signal is vented at the first handpiece selection valve 312a and the first water signal holdback valve 324a opens to allow a dental water air signal to flow when either a foot control is actuated or the flush toggle is activated. When the first dental device selection valve 312a is open, air is also supplied to a first air coolant holdback valve 314a associated with the first dental device 130a. The first air coolant holdback valve 314a prevents (or “holds back”) air from an air coolant needle valve 316. The air coolant needle valve 316 is connected to a dental air coolant source, such as a dental air source 110. In this example, the dental air source 110 provides pressurized air at 70-80 psi.

When the air coolant holdback valve is open, air coolant is supplied via the first line 318a to the first dental device 130a and is emitted at the distal end 320.

In the implementation shown in FIG. 4, a flush mode can be selectively activated to flush one or more of the dental devices. A flush signal toggle valve 328 is connected to a first water flush holdback valve 326a associated with the first dental device 130a, which is in turn connected to the first water coolant needle valve 325a. The flush signal toggle valve 328 is a two-position, four-way, normally open mechanical toggle valve with an inlet connected to a dental air source at 70-80 psi. The inlet is normally connected to one of the outlet ports, which provides a pilot air signal to the first water flush holdback valve 326a. When the flush signal toggle valve 328 is activated (e.g., manually), the pilot air signal is vented.

The first water flush holdback valve 326a is a two-position, two-way, pilot operated water valve. The pilot air signal from the flush signal toggle valve 328 closes the first water flush holdback valve 326a when the pilot air signal is present/pressurized (i.e., the toggle has not been activated). When the toggle of the flush signal toggle valve 328 is activated, the pilot air signal is vented, and the first water flush holdback valve 326a remains open, which allows a dental water flush stream to flow.

FIG. 5 is similar to FIG. 4, but also shows the branches of the circuit for the second dental device 130b and the third dental device 130c. Thus, there are corresponding components, including a second dental device selection valve 312b, a second air coolant holdback valve 314b, a second line 318b, a second water cartridge valve 322b, a third dental device selection valve 312c, a third air coolant holdback valve 314c, a third line 318c and a third water cartridge valve 322c. In addition, there is an optional air coolant solenoid valve 334 that can be activated to disable the supply of air to the air coolant needle valve 316. The air coolant solenoid valve 334 is electronically activated, such as from the user interface of a touchscreen or another electronic control.

As also shown in FIG. 5, some implementations have an optional water coolant signal solenoid valve 330. The water coolant signal solenoid valve 330 is an electronically controlled valve that can be activated, such as from the user interface or another electronic control, to disable the water coolant circuit.

As described, the following components of conventional circuits can be eliminated: (1) multiple manual water coolant needle valves (1-6 or more) are replaced by the single water coolant valve 202; (2) the operating knobs for the manual water coolant needle valves and their illuminated indicators are not needed; (3) the water flush holdback valve is not needed (which also eliminates a low flow path that is not desirable); (4) the flush signal toggle valve is not needed (its dual purposes of turning water valve on/off as well as sending a flush air signals are no longer needed); (5) multiple water cartridge valves are no longer needed due to the new water coolant valve (water on/off) and the new water coolant holdback valve (routing water to the desired dental device position); (6) no shuttle valve is needed; and (7) the optional water coolant signal solenoid valve is not needed.

### New Water Coolant and Air Coolant Circuit

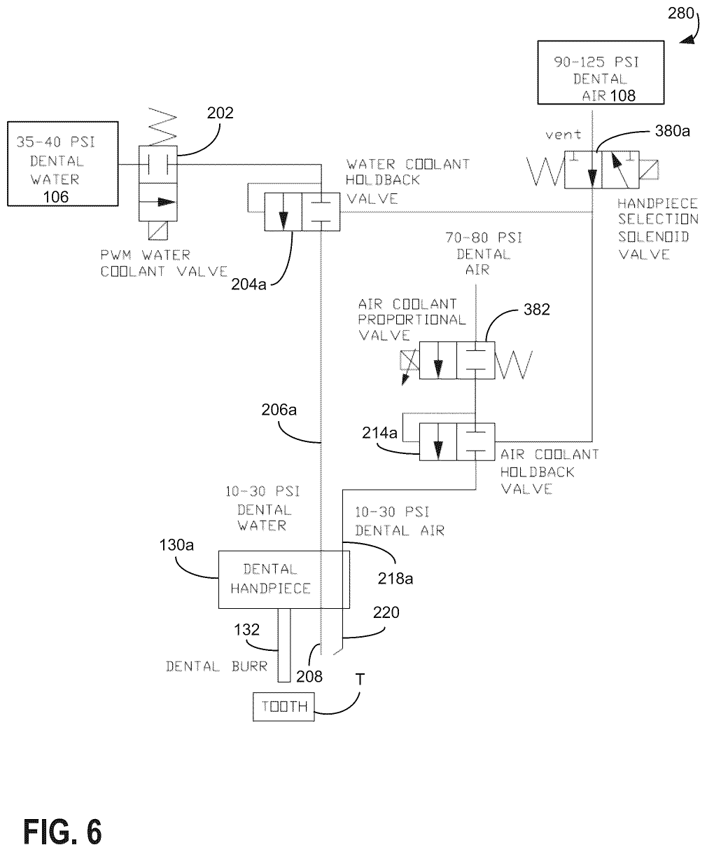

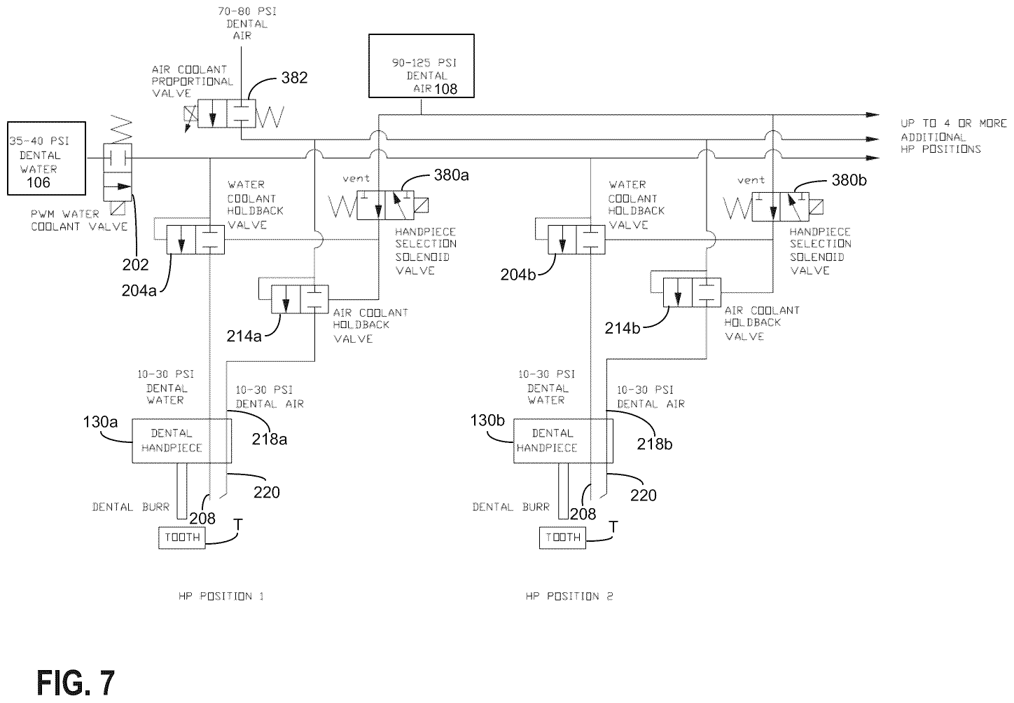

FIG. 6 is a circuit diagram for a circuit 280 having the single water coolant valve 202 as discussed above in connection with FIGS. 2 and 3, as well as a dental device selection solenoid valve instead of the mechanical dental device selection valve. In addition, the circuit 280 has a new air coolant proportional valve that provides air coolant to all dental device positions, instead of the air coolant needle valve needed for each dental device position. FIG. 7 is a circuit diagram similar to FIG. 6, except showing the components for multiple dental devices, including the first dental device 130a and the second dental device 130b.

The water coolant valve 202, the first water coolant holdback valve 204a for the first dental device 130a and the first line 206a are the same as described above in connection with FIG. 2. Instead of the first dental device selection valve 212a, which is a mechanical valve, there is an electronic first dental device selection valve 380a.

The first water coolant holdback valve 204a is connected to receive the pilot signal from the first dental device selection valve 380a. When the pilot signal is present/pressurized (i.e., the first dental device 130a is in its holder), the first water coolant holdback valve 204a is closed. The first dental device selection valve 380a is connected to a dental air source 108 that supplies dental air at 90-125 psi.

When the first dental device 130a is removed from its holder, the pilot signal is vented and the first water coolant holdback valve 204a opens to water coolant to flow.

Additionally, when the first dental device 130a is located in its holder, the presence of the pilot air signal from the first dental device selection valve 380a closes the first air coolant holdback valve 214a associated with the first dental device 130a. When the first dental device 130a is removed from its holder, the pilot air signal is vented, and the first air coolant holdback valve 214a opens to supply dental air coolant from an air coolant proportional valve.

With the air coolant proportional valve 382, it is not necessary to have the air coolant solenoid valve 334. With the air coolant proportional valve, different air coolant flow rates and/or pressures can be pre-programmed for each dental device position. It is also still possible to implement having a puff of air coolant emitted from the air coolant proportional valve after each time the foot control is deactivated (which is desirable to assist in removing droplets of water coolant from the dental device). Further, a stream of chip air can be provided through the air coolant proportional valve 382. Because the air coolant needle valve is eliminated, the mechanical adjusting knob needed for this valve is also eliminated, which reduces the number of required parts and connections, and also makes cleaning of the system easier and more effective. Existing mechanical foot controls can still be used, and electronic foot controls and other electronic devices (such as a heads-up display, etc.) are easier to integrate. If desired, closed loop control can be added.

In addition, enhanced features such as coolant flow management to provide for easier vision and/or better cooling can be implemented. User preferences for flow rates (e.g., to achieve sufficient cooling without producing too much mist) can be accommodated. Signal inputs such as tool load sense, cooling and vision can be detected and used to set coolant flow parameters.

### Additional Design Considerations

Dental water is supplied by dental units to various dental devices (also referred to as dental devices and/or instruments) used during patient treatment to cool the instruments and the dental tissue, as well as for assisting with flushing out debris and rinsing the oral cavity. Because the dental unit water contacts oral tissue and may be incidentally ingested, it must be of acceptable chemical and microbiological quality. Bacterial biofilm formation within dental unit waterlines is a particular challenge to maintaining acceptable dental unit water quality. Adding chemical agents to the dental unit water used during treatment and periodically administering cleaning/disinfecting solutions to the dental unit water system when the dental unit is not being used to treat patients are common strategies for controlling against biofilm formation. Dead-end passages, crevices and other regions in which water may not readily be circulated within a dental unit water system provide locations where bacterial biofilms can be established more easily and are potential sources of bacterial contamination in the dental unit water. The circuits and components described above are designed to reduce bacterial biofilms in the dental unit, thereby ensuring appropriate microbiological quality of the dental unit water.

Dental unit water is not intended for consumption as drinking water. But drinking water standards are frequently cited as a reference for dental unit water quality and some dental infection control authorities have incorporated drinking water requirements into guidelines or requirements for dental unit water. The maximum concentration of heterotrophic bacteria set by the EPA, the American Public Health Association (APHA) and the American Water Works Association (AWWA) is 500 CFU/mL of drinking water.

Consistently maintaining acceptable microbiological water quality requires that appropriate infection control measures are implemented. Additionally, the quality of water delivered by dental units should be regularly monitored to ensure standards compliance. Industry standards, such as ISO 7494-1 and ISO 7494-2, specify requirements for dental units, which are recognized by regulatory bodies in many countries. These include a requirement for dental unit water system components to be compatible with the dental waterline treatment recommendations by their manufacturer.

As described above, dental air is compressed air is supplied by dental units to various instruments used during patient treatment to mix with the water coolant to produce an atomized spray of water to cool cutting burrs and dental tissue. Compressed air is also used to power certain instruments (referred to as “drive air”). Compressed air is also used to assist with debris removal (referred to as “chip air”), to dry tooth surfaces and to evaluate tooth temperature sensitivity. Thus, appropriate control of chemical and microbiological quality of dental unit air is desirable.

Industry standards, such as ISO 22052, ISO 8573, ISO 7494-1 and ISO 7494-2, specify requirements relevant to dental air quality, which are recognized by regulatory bodies in many countries. The air purity class is established in accordance with ISO 8573-1. The quality of dental air is specified in ISO 22052. Flows, pressures, filtering, humidity, and oil content should meet the specific use requirements.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A water coolant circuit for a dental unit, comprising:
a plurality of defined dental device positions to which dental devices that use water coolant can be connected; and
a water coolant valve connected to the plurality of dental device positions and connectible to a pressurized water coolant source, wherein the water coolant valve is operable via pulse width modulation (PWM) and selectively controllable to supply the water coolant from the water coolant source to at least one of the plurality of dental device positions at a time.

2. The water coolant circuit of claim 1, wherein the water coolant valve is operated at a frequency of approximately 10-30 Hz.

3. The water coolant circuit of claim 1, wherein the water coolant valve is operated at a frequency of 15-25 Hz.

4. The water coolant circuit of claim 1, wherein the water coolant valve is operable at a duty cycle of 1-25% to supply the water coolant to the at least one of the plurality of dental device positions.

5. The water coolant circuit of claim 1, wherein the water coolant valve is operable in a flush mode at a duty cycle of 100% to supply the water coolant to the at least one of the plurality of dental device positions for flushing.

6. The water coolant circuit of claim 1, wherein the water coolant valve is a two-position, normally closed valve.

7. The water coolant valve of claim 1, wherein the water coolant valve has an isolation valve design.

8. The water coolant circuit of claim 1, wherein the water coolant valve is operable to supply the water coolant at a flow rate from 3 mL per minute to 500 mL per minute.

9. The water coolant circuit of claim 1, wherein the water coolant valve is operable to supply the water coolant at a flow rate from 5 mL per minute to 150 mL per minute.

10. The water coolant circuit of claim 1, wherein the plurality of dental device positions comprises at least one dental device position that receives pressurized air in addition to water coolant.

11. The water coolant circuit of claim 1, further comprising at least one connected dental device connected to one of the dental device positions, and wherein the water coolant valve is selectively controllable to supply water coolant through the connected dental device at a quasi-continuous flow rate.

12. The water coolant circuit of claim 1, further comprising a compliance member positioned downstream of the water coolant valve, wherein the compliance member attenuates pulsations in the water coolant flow from the water coolant valve.

13. The water coolant circuit of claim 12, wherein the compliance member comprises flexible tubing through which the water coolant flows.

14. The water coolant circuit of claim 12, wherein the compliance member comprises a flexible diaphragm of a valve member.

15. The water coolant circuit of claim 1, wherein the water coolant valve is operable in a flush mode to supply water coolant to one or more of the dental device positions simultaneously.

16. The water coolant circuit of claim 15, wherein, in the flush mode, substantially all flush flow is routed through the water coolant valve for simultaneous flushing of dental devices at the one or more of the dental device positions.

17. The water coolant circuit of claim 1, wherein the water coolant valve is connectible to an electrical power source, wherein in response to turning off electrical power or loss of electrical power supplied to the water coolant valve, the water coolant valve remains in an off state and water coolant flow is blocked.

18. A method of supplying dental water coolant in a dental delivery system, comprising:
providing a single water coolant valve connected to multiple dental device positions defined on a control head;
connecting the single water coolant valve to a pressurized dental water coolant source; and
operating the water coolant valve via electronic pulse width modulation (PWM) to selectively control a flow of dental water coolant from the single water coolant valve to at least a selected one of the multiple dental device positions.

19. A water coolant holdback valve for use in a dental unit, comprising:
a valve body having a valve inlet and a valve outlet for water coolant;
a flexible diaphragm positioned in the valve body between the valve inlet and the valve outlet, wherein the flexible diaphragm is selectively controllable to allow inflow of water coolant from the valve inlet and outflow of water coolant through the valve outlet and to shut off inflow of water coolant;
wherein the water coolant holdback valve is connectible within the dental unit downstream of a water coolant source and upstream of a dental device position at which a dental device can be connected.

20. The water coolant holdback valve of claim 19, further comprising a pilot control input, wherein a pilot control off signal forces the flexible diaphragm into an off position in which water coolant flow is prevented.

21. The water coolant holdback valve of claim 19, wherein the pilot control input is a pneumatic pressure signal.

22. The water coolant holdback valve of claim 19, wherein the pilot control input is a signal from a holder valve operably connected to a dental device holder, wherein the pilot control input is configured to change from a closed signal to an open signal when the holder valve changes to indicate that a dental device has been removed from the dental device holder.

23. The water coolant holdback valve of claim 19, wherein the water coolant holdback valve is configured to prevent drips from the dental device when the dental device is returned to the dental device holder.

24. The water coolant holdback valve of claim 19, wherein the water coolant holdback valve is configured to prevent water drops from forming at the outlet of the dental device.

25. The water coolant holdback valve of claim 19, further comprising at least one biasing member configured to bias the diaphragm towards a closed position.

26. The water coolant holdback valve of claim 19, wherein the diaphragm is pilot controlled by a pilot on or a pilot off signal, wherein the water coolant holdback valve comprises four states of operation:
a first OFF state in which the pilot signal is on and no inflow of water coolant is present at the valve inlet;
a second OFF state in which the pilot signal is on and inflow of water coolant is present at the valve inlet;
a third ON state in which the pilot signal is off and inflow of water coolant is present at the valve inlet and outflow of water coolant is present at the valve outlet;
a fourth OFF state in which the pilot signal is off and no inflow of water coolant is present at the valve inlet.

27. The water coolant holdback back valve of claim 19, wherein the diaphragm is pilot controlled by a pneumatic signal in the range of 70-125 psi.

28. An air coolant proportional valve for supplying air coolant in a dental unit, comprising:
a valve inlet connected to a pressurized air source;
a valve outlet selectively connectible to one of a plurality of dental device assigned positions to which a respective plurality of dental devices can be connected; and
an electrical control circuit via which the pneumatic proportional valve receives signals to selectively control supply of air coolant to at least a selected one of the dental device assigned positions.

29. The air coolant proportional valve of claim 28, wherein the electrical control circuit receives an air coolant supply signal corresponding to the selected one of the dental device positions and specifying a flow rate and/or a pressure for supplying air coolant to the selected one of the dental device positions.

30. The air coolant proportional valve of claim 29, wherein the air coolant supply signals for the plurality of dental device assigned positions are stored in a memory.

31. The air coolant proportional valve of claim 29, wherein the air coolant supply signal corresponding to the selected one of the dental device positions is set by a user using a touch interface connected to the dental unit.

32. The pneumatic proportional valve of claim 28, wherein the dental unit is connected to one or more sensing devices selected from a tool load sensor, a microphone, an optical sensor or a temperature sensor, and wherein signals from the one or more sensing devices modify the signals received by the electrical control circuit.
